(19) United States
(12) Patent Application Publication
(10) Pub. No.: US 2014/0259150 A1
(43) Pub. Date: Sep. 11, 2014

(54) METHOD AND APPARATUS FOR RECOGNIZING PATTERN

(71) Applicant: Samsung Electronics Co., Ltd., Gyeonggi-do (KR)

(72) Inventor: Ji-Woo Lee, Gyeongsangbuk-do (KR)

(73) Assignee: Samsung Electronics Co., Ltd., Gyeonggi-do (KR)

(21) Appl. No.: 14/201,657

(22) Filed: Mar. 7, 2014

(30) Foreign Application Priority Data
Mar. 8, 2013 (KR) 10-2013-0025112

(51) Int. Cl. G06F 21/36

(52) U.S. Cl. CPC G06F 21/36
USPC 726/16

(57) ABSTRACT

A method in an electronic device is provided. The method includes displaying a polygon comprising a plurality of line segments on a screen, receiving a drag input from a user, and detecting at least one intersection between the drag input and one of the plurality of line segments. An electronic device for receiving a pattern is provided. The electronic device includes at least one memory, a display, and at least one processor configured to display a polygon comprising a plurality of line segments on a screen, receive a drag input from a user, and detect at least one intersection between the drag input and one of the plurality of line segments. Other various embodiments are also disclosed.

### PRIORITY

The present application is related to and claims the benefit under 35 U.S.C. §119(a) of a Korean patent application No. 10-2013-0025112 filed in the Korean Intellectual Property Office on Mar. 8, 2013, the entire disclosure of which is hereby incorporated by reference.

### TECHNICAL FIELD

The present disclosure relates to a method of controlling a pattern and an electronic device thereof.

### BACKGROUND

Each of portable electronic devices which have become each of necessities of modern people due to ease of carrying it has been developed into each of multimedia devices which provide various multimedia services such as an audio and video communication service, an information input and output service, and a data transmission and reception service.

A user of each of the electronic devices sets a password using a keypad or set a pattern using touch information to limit personal information and services included in the electronic device. Herein, when the user of the electronic device sets a point-to-point pattern, it is apprehended that the set pattern is exposed to others because a range which may determine degree of difficulty of a pattern is limited and simple.

Therefore, it is needed to provide an improved interface for controlling a pattern in the electronic device.

### SUMMARY

A method in an electronic device is provided. The method includes displaying a polygon comprising a plurality of line segments on a screen, receiving a drag input from a user, and detecting at least one intersection between the drag input and one of the plurality of line segments.

In certain embodiments, the method includes determining a pattern based on a sequence of at least one intersection.

In certain embodiments, the method includes assigning each integer or letter to each of the plurality of line segments; and

In certain embodiments, the method includes producing a code by converting each intersection on the line segment to respective assigned integers or letters of the line segments.

In certain embodiments, the method includes recognizing an image from the received drag input.

In certain embodiments, the method includes determining a pattern based on a sequence of at least one intersection.

In certain embodiments, the method includes assigning different integers or letters to each of the plurality of line segments based on whether the pattern comprises a clockwise arc or a counter-clockwise arc.

In certain embodiments, the method includes producing a code by converting each intersection on the line segment to respective assigned integers or letters of the line segments.

In certain embodiments, the method includes unlocking the screen when the pattern matches a preset pattern.

In certain embodiments, the polygon is a triangle or rectangle.

In certain embodiments, the method includes unlocking an application program when the code matches a password.

An electronic device for receiving a pattern is provided. The electronic device includes

at least one memory, a display, and at least one processor configured to display a polygon comprising a plurality of line segments on a screen, receive a drag input from a user, and detect at least one intersection between the drag input and one of the plurality of line segments.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating configuration of an electronic device according to one embodiment of the present disclosure;

FIG. 2 is a block diagram illustrating detailed configuration of a processor according to one embodiment of the present disclosure;

FIG. 3A is a flowchart illustrating a process of setting a pattern using a polygon in an electronic device according to one embodiment of the present disclosure;

FIG. 3B is a block diagram illustrating configuration of an electronic device for setting a pattern using a polygon according to one embodiment of the present disclosure;

FIG. 4 is a flowchart illustrating a process of setting a pattern using a polygon in an electronic device according to another embodiment of the present disclosure;

FIG. 5 is a flowchart illustrating a process of setting a pattern using a polygon in an electronic device according to another embodiment of the present disclosure;

FIG. 6A is a flowchart illustrating a process of releasing a pattern using a polygon in an electronic device according to one embodiment of the present disclosure;

FIG. 6B is a block diagram illustrating configuration of an electronic device for releasing a pattern using a polygon according to one embodiment of the present disclosure;

FIG. 7 is a flowchart illustrating a process of releasing a pattern using a polygon in an electronic device according to another embodiment of the present disclosure;

FIG. 8 is a flowchart illustrating a process of releasing a pattern using a polygon in an electronic device according to another embodiment of the present disclosure;

FIGS. 9A to 9D are screens illustrating a process of controlling a pattern using a triangle in an electronic device according to one embodiment of the present disclosure;

FIGS. 10A to 10C are screens illustrating a process of controlling a pattern using a rectangle in an electronic device according to one embodiment of the present disclosure; and

FIGS. 11A to 11D are screens illustrating a process of controlling a pattern using an image in an electronic device according to one embodiment of the present disclosure.

### DETAILED DESCRIPTION

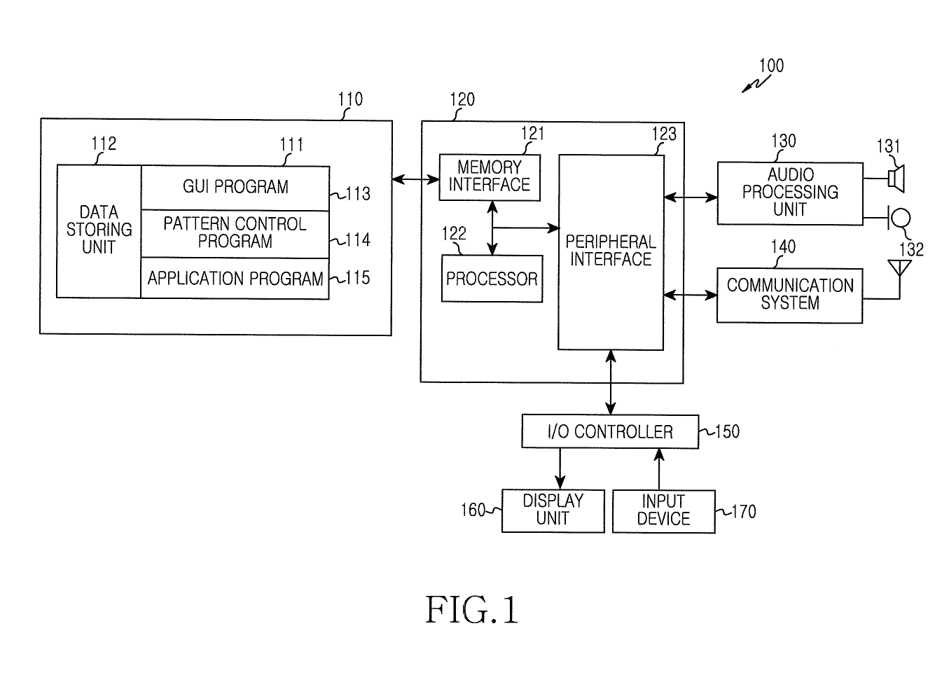

FIGS. 1 through 11D, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. Exemplary embodiments of the present disclosure will be described herein below with reference to the accompanying drawings. In the following description, well-known functions or constructions are not described in detail since they would obscure the disclosure in unnecessary detail.

Hereinafter, a description will be given for an apparatus and method for controlling a pattern using a polygon in an electronic device.

Hereinafter, the electronic device includes at least one of a mobile communication terminal, a Personal Digital Assistant (PDA), a laptop computer, a smart phone, a netbook, a television, a Mobile Internet Device (MID), a Ultra Mobile Personal Computer (UMPC), a tablet PC, a navigation device, refrigerator, a digital watch, a digital camera, and a Moving Picture Experts Group (MPEG) layer 3 (MP3) player, etc.

The present disclosure relates to a method of setting and releasing a pattern using a polygon and an electronic device thereof.

FIG. 1 is a block diagram illustrating configuration of an electronic device according to one embodiment of the present disclosure.

As shown in FIG. 1, the electronic device denoted by 100 can include a memory 110, a processor unit 120, an audio processing unit 130, a communication system 140, an Input/Output (I/O) controller 150, a display unit 160, and an input device 170. Herein, the memory 110 can be a plurality of memories.

A description will be given for each component as follows.

The memory 110 can include a program storing unit 111 for storing programs for controlling operations of the electronic device 100 and a data storing unit 112 for storing data generated while the programs are executed.

The program storing unit 111 can include a Graphic User Interface (GUI) program 113, a pattern control program 114, and at least one application program 115. Herein, the programs included in the program storing unit 111 can be expressed in an instruction set as a set of instructions.

The data storing unit 112 can include at least one software component for storing pattern control information. For one example, the data storing unit 112 can store numbers of line segments forming a polygon for setting a pattern. For another example, the data storing unit 112 can store numbers of line segments for determining whether to release a pattern.

The GUI program 113 can include at least one software component for providing a UI as graphics on the display unit 160. For example, the GUI program 113 can control the display unit 160 to display a polygon for setting a pattern by the pattern control program 114. For another example, the GUI program 113 can control the display unit 160 to display a polygon for releasing a pattern by the pattern control program 114.

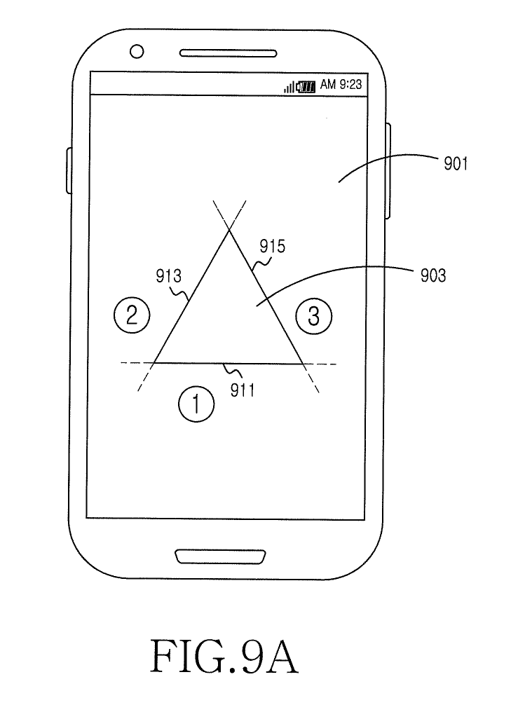

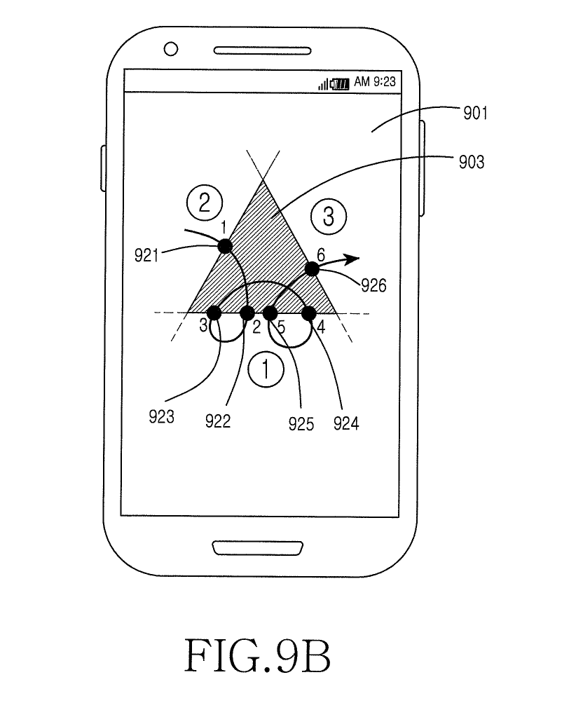

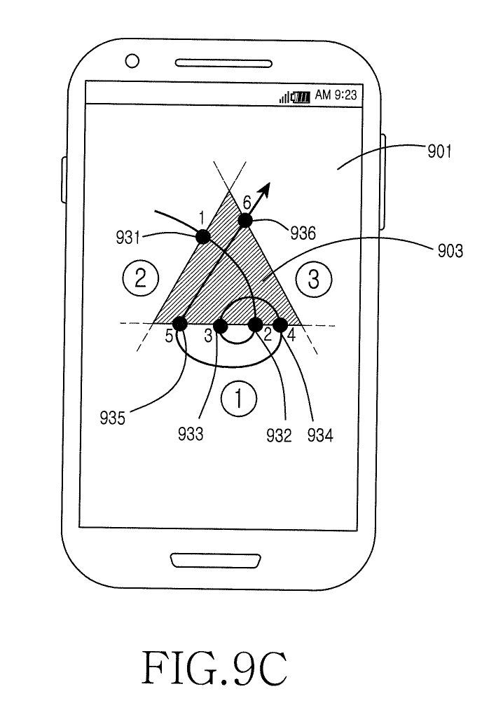

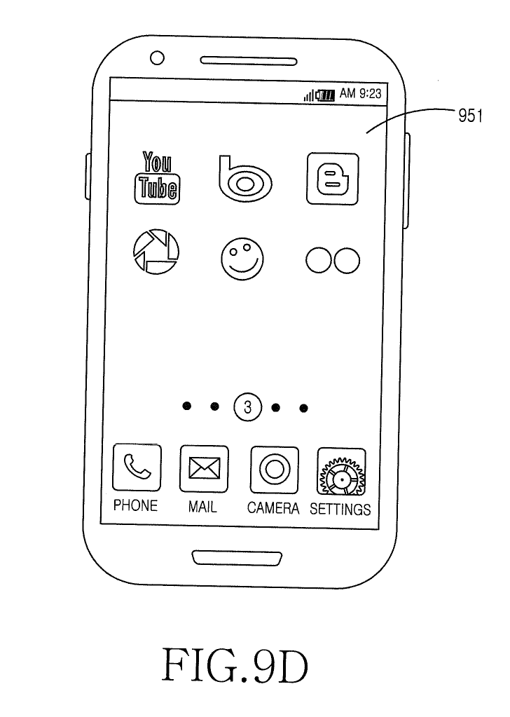

The pattern control program 114 can include at least one software component for performing a control operation to set a pattern using a polygon. For example, as shown in FIG. 9A, when a triangle 903 for setting a pattern is displayed on a touch panel 901, the pattern control program 114 can assign 1, 2, and 3 for a first line segment 911, a second line segment 913, and a third line segment 915 of the triangle 903, respectively. After assigning numbers for the first to third line segments 911, 913, and 915 forming the triangle 903, as shown in FIG. 9B, when a pattern including a first intersection 921 to a second intersection 922, a third intersection 923, a 4^{th} intersection 924, a 5^{th} intersection 925, and a 6^{th} intersection 926 is sensed, the pattern control program 114 can converts these intersections into a code of “211113” based on the assigned numbers of line segments on which the drag is crossed.

Also, the pattern control program 114 can include at least one software component for performing a control operation to release a pattern using a polygon. For example, as shown in FIG. 9A, when the triangle 903 for releasing a pattern is displayed on the touch panel 901, the pattern control program 114 can verify that numbers of the first to third line segments 911, 913, and 915 which form the triangle 903 are 1, 2, and 3, respectively. After verifying the numbers of the first to third line segments 911, 913, and 915 forming the triangle 903, as shown in FIG. 9B, when the touch movement which moves to the first intersection 921, the second intersection 922, the third intersection 923, the 4^{th} intersection 924, the 5^{th} intersection 925, and the 6^{th} intersection 926 is sensed, the pattern control program 114 can perforin a control operation to release a pattern in consideration of the numbers “211113” of the line segments on which the touches are sensed.

The application program 115 includes a software component for at least one application program installed in the electronic device 100.

The processor unit 120 can include a memory interface 121, at least one processor 122, and a peripheral interface 123. Herein, the memory interface 121, at least the one processor 122, and the peripheral interface 123 which are included in the processor unit 120 can be integrated in at least one Integrated Circuit (IC) or be separately implemented.

The memory interface 121 controls that a component like the processor 122 or the peripheral interface 123 accesses the memory 110.

The peripheral interface 123 controls connection among an I/O peripheral of the electronic device 100, the processor 122, and the memory interface 121.

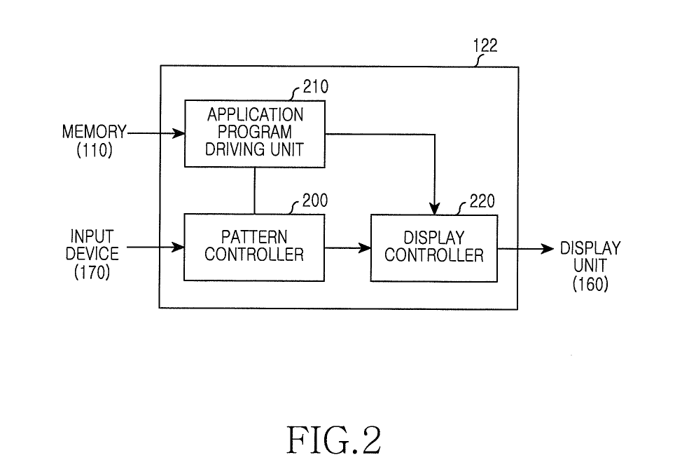

The processor 122 performs a control operation to provide a variety of services using at least one software program. Herein, the processor 122 performs a control operation to execute at least one program stored in the memory 110 and provide a service according to the corresponding program. For example, as shown in FIG. 2B, the processor 122 can be configured to perform a control operation to execute the pattern control program 114 and set and release a pattern using a polygon.

The audio processing unit 130 provides an audio interface between a user and the electronic device 100 through a speaker 131 and a microphone 132.

The communication system 140 can include at least one software component for performing a communication function for voice and data communication. Herein, the communication system 140 can be classified into a plurality of communication sub-modules which support different communication networks. For example, the communication network can include, but is not limited to, any one of a Global System for Mobile communication (GSM) network, an Enhanced Data GSM Environment (EDGE) network, a Code Division Multiple Access (CDMA) network, a W-CDMA network, a Long Term Evolution (LIE) network, an Orthogonal Frequency Division Multiple Access (OFDMA) network, a wireless Local Area Network (LAN), a Bluetooth network, a Near Field Communication (NFC) network, etc.

The I/O controller 150 provides an interface between I/O devices, such as the display device 160 and the input device 170, and the peripheral interface 123.

The display unit 160 displays state information of the electronic device 100, characters input by the user, moving pictures, still pictures, etc. For one example, the display unit 160 can display information of an application program executed by the processor 122. For another example, the display unit 160 can display a polygon for setting a pattern, which is provided from the pattern control program 114, according to control of the GUI program 113. For another example, the display unit 160 can display a polygon for releasing a pattern, which is provided from the pattern control program 114, according to control of the GUI program 113.

The input device 170 provides input data generated by selection of the user to the processor unit 120 through the I/O controller 150. Herein, the input device 170 can include a keypad including at least one hardware button, a touch pad for sensing touch information, etc. For example, the input device 170 provides touch information sensed through the touch pad to the processor 122 through the I/O controller 150.

FIG. 2 is a block diagram illustrating detailed configuration of a processor according to one embodiment of the present disclosure.

As shown in FIGS. 1 and 2, the processor 122 includes a pattern controller 200, an application program driving unit 210, and a display controller 220.

The pattern controller 200 performs a control operation to execute the pattern control program 114 of the program storing unit 111 and set a pattern using a polygon. For example, as shown in FIG. 9A, when for example, a triangle 903 for setting a pattern is displayed on a touch panel 901, the pattern controller 200 can assign, for example, 1, 2, and 3 to a first line segment 911, a second line segment 913, and a third line segment 915 which form the triangle 903, respectively. After assigning numbers or letters to each line segments 911, 913, and 915 forming the triangle 903, as shown in FIG. 9B, when a touch movement which moves from a first intersection 921 to a second intersection 922, a third intersection 923, a 4^{th} intersection 924, a 5^{th} intersection 925, and a 6^{th} intersection 926 is sensed, the pattern controller 200 can perform a control operation to determine a pattern in consideration of numbers “211113” of line segments on which touches are sensed.

Also, the pattern controller 200 executes the pattern control program 114 of the programs storing unit 111 and releases a pattern using a polygon. For example, as shown in FIG. 9A, when the triangle 903 for releasing a pattern is displayed on the touch panel 901, the pattern controller 200 can produce a code consisting of numbers of the first to third line segments 911, 913, and 915 which form the triangle 903 are 1, 2, and 3, respectively. After verifying the numbers of the first to third line segments 911, 913, and 915 forming the triangle 903, as shown in FIG. 9B, when the touch movement which moves to the first intersection 921, the second intersection 922, the third intersection 923, the 4^{th} intersection 924, the 5^{th} intersection 925, and the 6^{th} intersection 926 is sensed, the pattern controller 200 can perform a control operation to release a pattern in consideration of the numbers “211113” of the line segments on which the touches are sensed.

The display controller 220 executes the GUI program 113 of the program storing unit 111 and provides a UI as graphics on the display unit 160. For one example, the display controller 220 can control the display unit 160 to display a polygon for setting a pattern by the pattern controller 200. For another example, the display controller 220 can control the display unit 160 to display a polygon for releasing a pattern by the pattern controller 200.

In the above-described one embodiment of the present disclosure, the pattern controller 200 of the electronic device 100 can perform the control operation to execute the pattern control program 114 and set and release the pattern using the polygon.

In another embodiment of the present disclosure, the electronic device 100 can include a separate pattern controller including the pattern control program 114.

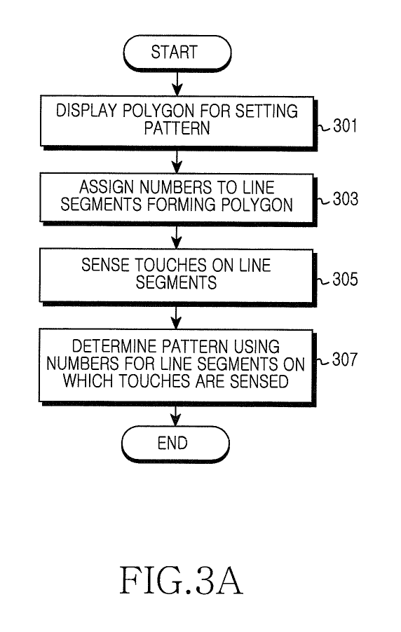

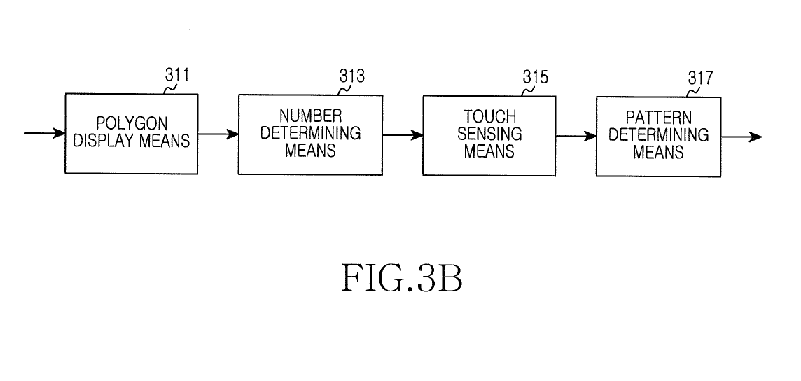

FIG. 3A is a flowchart illustrating a process of setting a pattern using a polygon in an electronic device according to one embodiment of the present disclosure.

Referring to FIG. 3A, the electronic device displays a polygon for setting a pattern in step 301. For example, as shown in FIG. 9A, the electronic device can display a triangle 903 for setting a pattern on a touch panel 901.

After displaying the polygon for setting the pattern, the electronic device determines numbers for line segments forming the polygon in step 303. For example, as shown in FIG. 9A, displaying the triangle 903 for setting the pattern on the touch panel 901, the electronic device can assign, i.e., 1, 2, and 3 for a first line segment 911, a second line segment 913, and a third segment 915 which form the triangle 903, respectively. Herein, the electronic device can first assign 1 for at least one line segment forming the polygon and assign numbers or letters for the others clockwise. Also, the electronic device can first determine 1 for at least one line segment forming the polygon and determine numbers for the others counterclockwise. Also, the electronic device can randomly determine numbers for line segments forming the polygon.

After determining the numbers for the line segments forming the polygon, the electronic device senses touches for the line segments in step 305.

After sensing the touches for the line segments, the electronic device determines a pattern using the numbers for the line segments on which the intersectiones are sensed. For example, as shown in FIG. 9B, when a touch movement which moves from a first intersection 921 to a second intersection 922, a third intersection 923, a 4^{th} intersection 924, a 5^{th} intersection 925, and a 6^{th} intersection 926 is sensed, the electronic device can store “211113” as numbers of the line segments on which the touches are sensed. When a touch is released after the first intersection 921, the second intersection 922, the third intersection 923, the 4^{th} intersection 924, the 5^{th} intersection 925, and the 6^{th} intersection 926 is successively sensed, the electronic device can determine a pattern in consideration of the numbers “211113” of the line segments on which the touches are sensed. Herein, the electronic device can determine a pattern in consideration of a reverse order for the numbers of the line segments.

Thereafter, the electronic device ends the algorithm of FIG. 3A.

As described above, the process of performing the control operation to set the pattern using the polygon in the electronic device can be configured, as shown in FIG. 3B, an apparatus for performing the control operation to set the pattern using the polygon in the electronic device.

FIG. 3B is a block diagram illustrating configuration of an electronic device for setting a pattern using a polygon according to one embodiment of the present disclosure.

Referring to FIG. 3B, the electronic device can include a polygon display means, that is, a first means 311 for displaying a polygon for setting a pattern, a number determining means, that is, a second means 313 for determining numbers for line segments forming the polygon, a touch sensing means, that is, a third means 315 for sensing touches on the line segments, and a pattern determining means, that is, a 4^{th} means 317 for determining a pattern using the numbers for the line segments on which the touches are sensed.

The first means 311 displays the polygon for setting the pattern. For example, as shown in FIG. 9A, the first means 311 can display a triangle 903 for setting a pattern on a touch panel 901.

The second means 313 determines the numbers for the line segments forming the polygon. For example, as shown in FIG. 9A, displaying the triangle 903 for setting the pattern on the touch panel 901, the second means 313 can determine 1, 2, and 3 for a first line segment 911, a second line segment 913, and a third segment 915 which form the triangle 903, respectively. Herein, the second means 313 can first determine 1 for at least one line segment forming the polygon and determine numbers for the others clockwise. Also, the second means 313 can first determine 1 for at least one line segment forming the polygon and determine numbers for the others counterclockwise. Also, the second means 313 can randomly determine numbers for line segments forming the polygon.

The third means 315 senses the touches on the line segments.

The 4^{th} means 317 determines the pattern using the numbers for the line segments on which the touches are sensed. For example, as shown in FIG. 9B, when a touch movement which moves from a first intersection 921 to a second intersection 922, a third intersection 923, a 4^{th} intersection 924, a 5^{th} intersection 925, and a 6^{th} intersection 926 is sensed, the 4^{th} means 317 can store “211113” as numbers of the line segments on which the touches are sensed. When a touch is released after the first intersection 921, the second intersection 922, the third intersection 923, the 4^{th} intersection 924, the 5^{th} intersection 925, and the 6^{th} intersection 926 are successively sensed, the 4^{th} means 317 can determine a pattern in consideration of the numbers “211113” of the line segments on which the touches are sensed. Herein, the 4^{th} means 317 can determine a pattern in consideration of a reverse order for the numbers of the line segments.

In addition, the electronic device can further include at least one means before the first means 311 and after the 4^{th} means 317

As described above, the electronic device can include a plurality of means for performing the control operation to set the pattern using the pattern. Herein, the electronic device can include the plurality of means for performing the control operation to set the pattern using the polygon as one means.

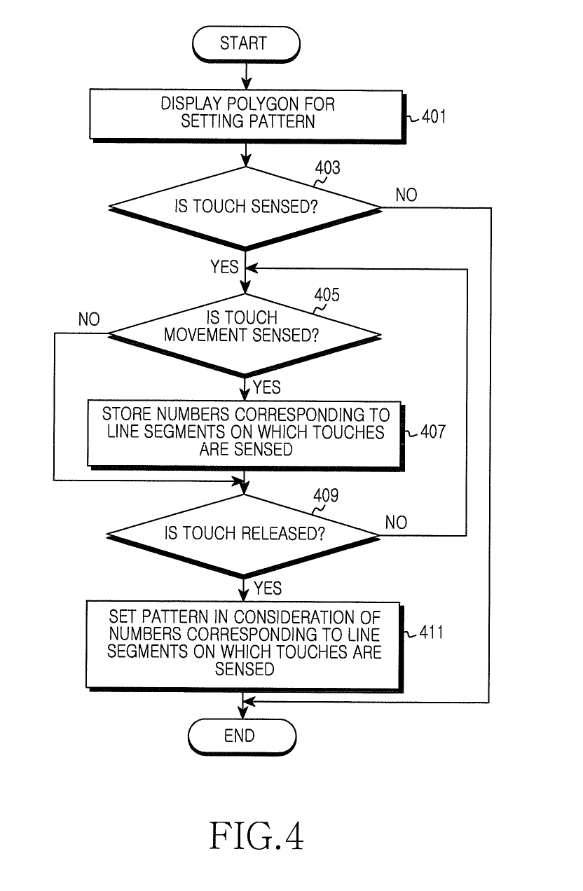

FIG. 4 is a flowchart illustrating a process of setting a pattern using a polygon in an electronic device according to another embodiment of the present disclosure.

Referring to FIG. 4, the electronic device can display a polygon for setting a pattern in step 401. For example, as shown in FIG. 9A, the electronic device can display a triangle 903 for setting a pattern on a touch panel 901. Herein, the electronic device can verify predetermined numbers for a first line segment 911, a second line segment 913, and a third segment 915 which form the triangle 903, respectively. For example, the electronic device can verify that the first line segment 911 is 1, the second line segment 913 is 2, and the third line segment 915 is 3.

After displaying the polygon for setting the pattern, the electronic device can verify whether a touch is sensed in step 403. If the touch is not sensed, the electronic device can end the algorithm of FIG. 4.

On the other hand, when the touch is sensed, the electronic device can verify whether a touch movement is sensed in step 405. If the touch movement is not sensed, the electronic device can verify whether the touch is released in step 409.

On the other hand, when the touch movement is sensed, the electronic device can store numbers for line segments on which the touches are sensed in step 407. For example, as shown in FIG. 9B, when a touch movement which moves from a first intersection 921 to a second intersection 922, a third intersection 923, a 4^{th} intersection 924, a 5^{th} intersection 925, and a 6^{th} intersection 926 is sensed, the electronic device can store “211113” as numbers of the line segments on which the touches are sensed.

After storing the numbers for the line segments on which the touches are sensed, the electronic device can recognize whether the touch is released in step 409. If the touch is not released, the electronic device can continue to monitor whether a touch movement for line segments is sensed in step 405.

On the other hand, when the touch is released, the electronic device can set a pattern in consideration of the numbers for the line segments on which the touches are sensed in step 411. For example, as shown in FIG. 9B, when a touch is released after the first intersection 921, the second intersection 922, the third intersection 923, the 4^{th} intersection 924, the 5th intersection 925, and the 6^{th} intersection 926 are successively sensed, the electronic device can determine a pattern in consideration of the numbers “211113” of the line segments on which the touches are sensed. Herein, the electronic device can determine a pattern in consideration of a reverse order for the numbers of the line segments.

Thereafter, the electronic device can end the algorithm of FIG. 4.

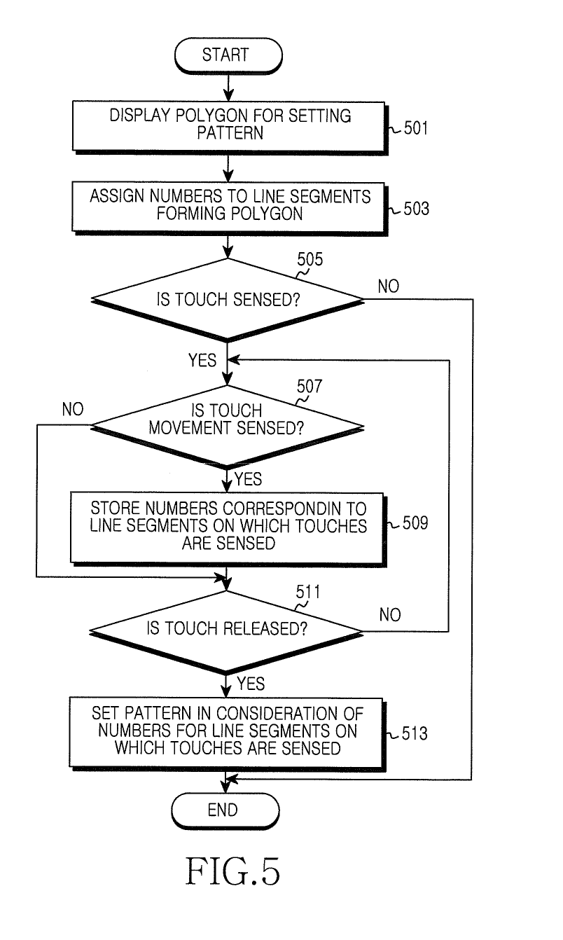

FIG. 5 is a flowchart illustrating a process of setting a pattern using a polygon in an electronic device according to another embodiment of the present disclosure.

Referring to FIG. 5, the electronic device displays a polygon for setting a pattern in step 501. For example, as shown in FIG. 9A, the electronic device can display a triangle 903 for setting a pattern on a touch panel 901.

After displaying the polygon for setting the pattern, the electronic device can determine numbers for line segments forming the polygon in step 503. For example, as shown in FIG. 9A, displaying the triangle 903 for setting the pattern on the touch panel 901, the electronic device can determine 1, 2, and 3 for a first line segment 911, a second line segment 913, and a third segment 915 which form the triangle 903, respectively. Herein, the electronic device can first determine 1 for at least one line segment forming the polygon and determine numbers for the others clockwise. Also, the electronic device can first determine 1 for at least one line segment forming the polygon and determine numbers for the others counterclockwise. Also, the electronic device can randomly determine numbers for line segments forming the polygon.

After determining the numbers for the line segments forming the polygon, the electronic device can verify whether a touch is sensed in step 505. If the touch is not sensed, the electronic device can end the algorithm of FIG. 5.

On the other hand, when the touch is sensed, the electronic device can verify whether a touch movement is sensed in step 507. If the touch movement is not sensed, the electronic device can continue to monitor whether the touch is released in step 511.

On the other hand, when the touch movement is sensed, the electronic device can store numbers for line segments on which the touches are sensed in step 509. For example, as shown in FIG. 9B, when a touch movement which moves from a first intersection 921 to a second intersection 922, a third intersection 923, a 4^{th} intersection 924, a 5^{th} intersection 925, and a 6^{th} intersection 926 is sensed, the electronic device can store “211113” as numbers of the line segments on which the touches are sensed.

After storing the numbers for the line segments on which the touches are sensed, the electronic device can recognize whether the touch is released in step 511. If the touch is not released, the electronic device can continue to monitor whether a touch movement for line segments is sensed in step 507.

On the other hand, when the touch is released, the electronic device can set a pattern in consideration of the numbers for the line segments on which the touches are sensed in step 513. For example, as shown in FIG. 9B, when a touch is released after the first intersection 921, the second intersection 922, the third intersection 923, the 4^{th} intersection 924, the 5^{th} intersection 925, and the 6^{th} intersection 926 are successively sensed, the electronic device can determine a pattern in consideration of the numbers “211113” of the line segments on which the touches are sensed. Herein, the electronic device can determine a pattern in consideration of a reverse order for the numbers of the line segments.

Thereafter, the electronic device can end the algorithm of FIG. 5.

In the above-described one embodiment of the present disclosure, the electronic device can set the pattern in consideration of the touches on the line segments forming the triangle.

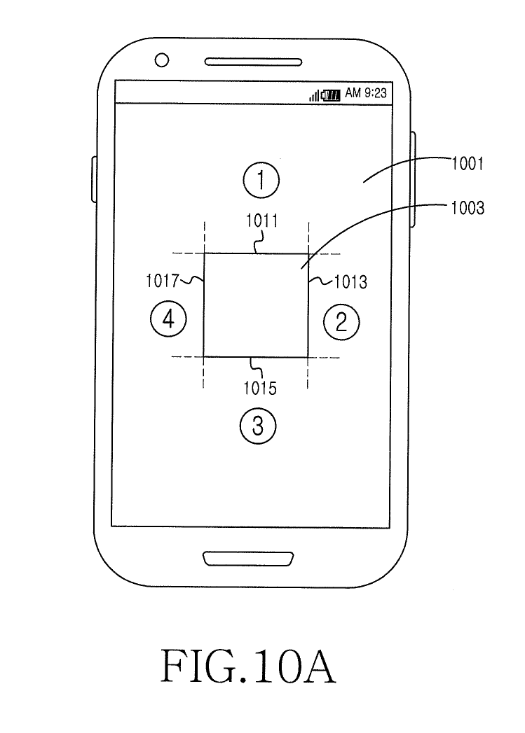

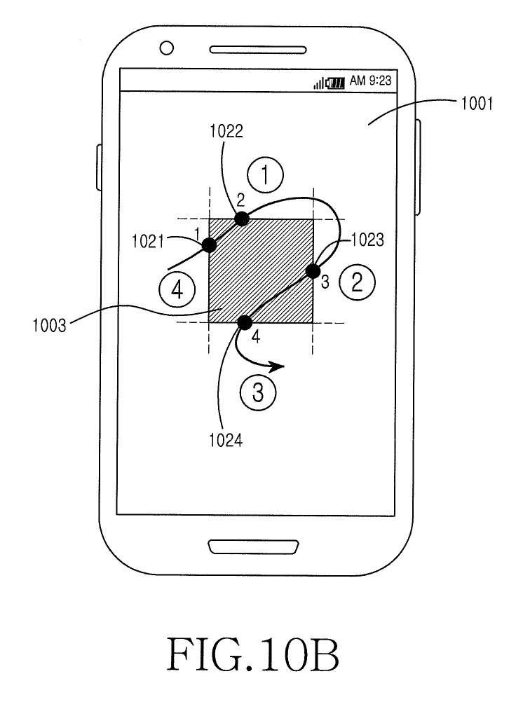

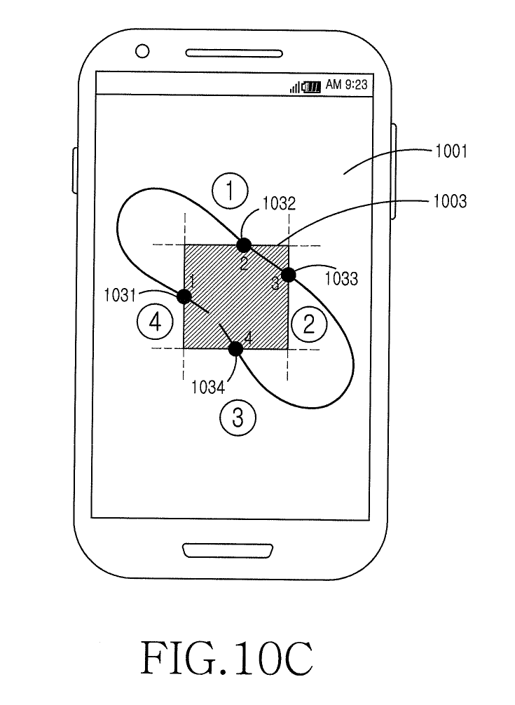

In another embodiment of the present disclosure, the electronic device can set a pattern in consideration of touches on line segments forming a rectangle. For example, as shown in FIG. 10A, displaying a rectangle 1003 for setting a pattern on a touch panel 1001, the electronic device can set a pattern in consideration of touch information about a first line segment 1011, a second line segment 1013, a third line segment 1015, and a 4^{th} line segment 1017 which form the rectangle 1003. For example, as shown in FIG. 10B, when a first intersection 1021, a second intersection 1022, a third intersection 1023, and a 4^{th} intersection 1024 on at least one line segment forming the rectangle 1003 are sensed, the electronic device can set a pattern in consideration of numbers “4123” of the line segments on which the touches are sensed.

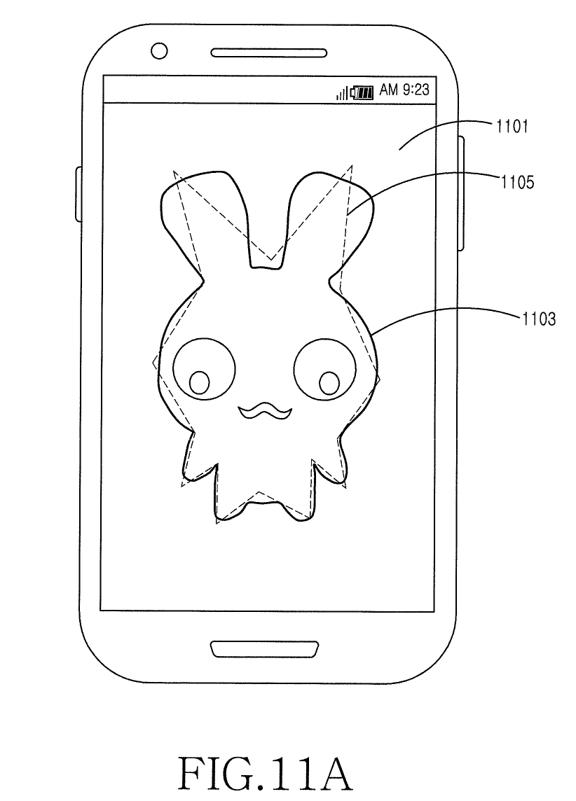

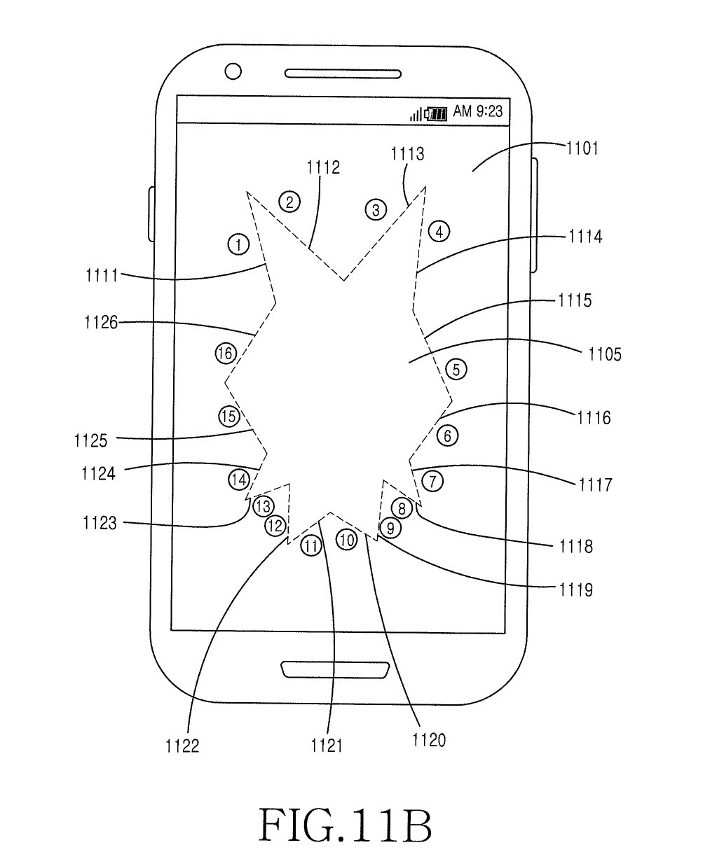

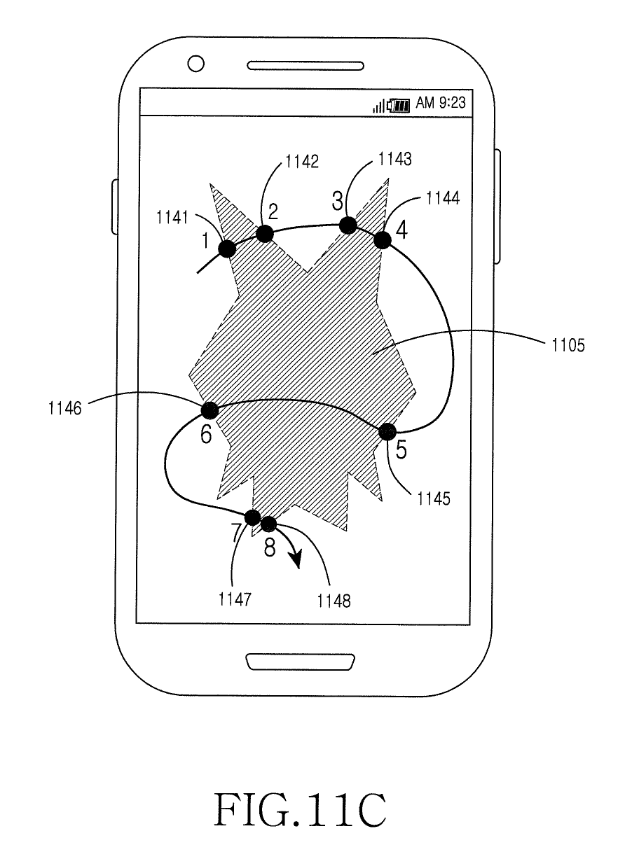

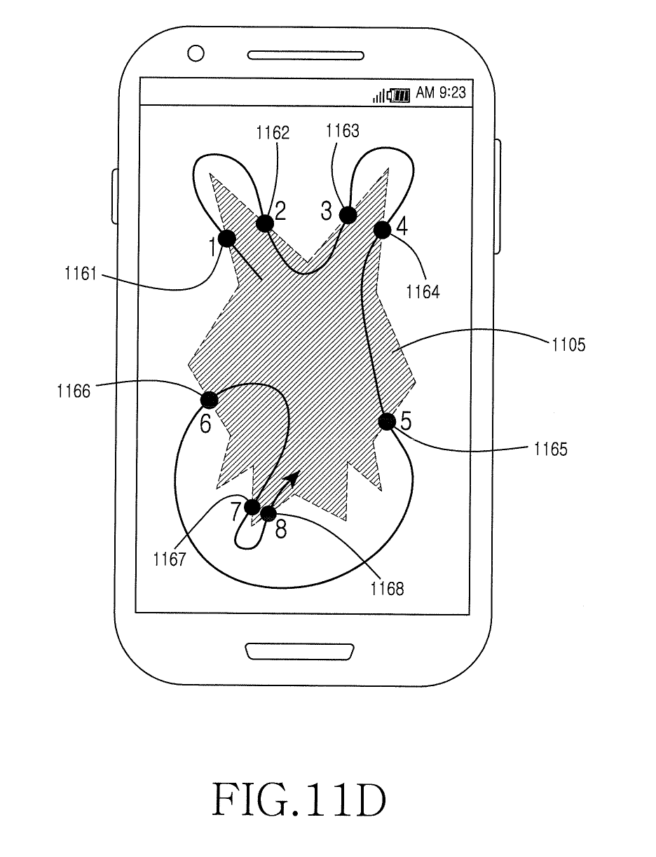

In another embodiment of the present disclosure, the electronic device can convert an image into a polygon and set a pattern using the converted polygon. For example, displaying an image 1103 for setting a pattern on a touch panel 1101, the electronic device can recognize the image 1103 as a polygon 1105. Herein, as shown in FIG. 11B, the electronic device can set a pattern in consideration of touch information about first to 16^{th} line segments 1111 to 1126 forming the 16-polygon 1105. For example, as shown in FIG. 11C, a first intersection 1141, a second intersection 1142, a third intersection 1143, a 4^{th} intersection 1144, a 5^{th} intersection 1145, a 6^{th} intersection 1146, a 7^{th} intersection 1147, and an 8^{th} intersection 1148 on at least one line segment forming the 16-polygon 1105 are sensed, the electronic device can set a pattern in consideration of numbers “12346151211” of the line segments on which the touches are sensed.

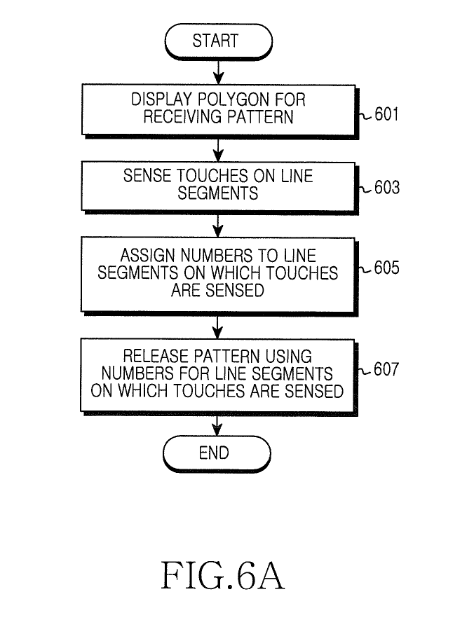

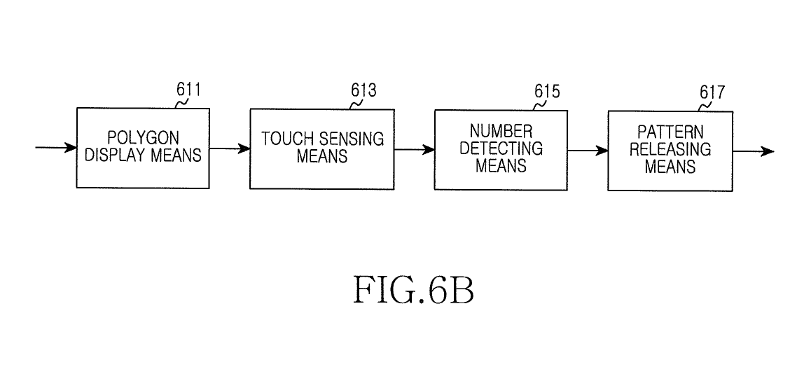

FIG. 6A is a flowchart illustrating a process of releasing a pattern using a polygon in an electronic device according to one embodiment of the present disclosure.

Referring to FIG. 6A, the electronic device displays a polygon for releasing a pattern in step 601. For example, as shown in FIG. 9A, the electronic device can display a triangle 903 for releasing a pattern on a touch panel 901. Herein, the electronic device can verify that a first line segment 911 forming the triangle 903 is 1, a second line segment 913 is 1, and a third segment 915 is 3.

After displaying the polygon for releasing the pattern, the electronic device can sense touches on line segments in step 603.

After sensing the touches on the line segments, the electronic device can detect numbers for the line segments on which the touches are sensed. For example, as shown in FIG. 9B, when a touch movement which moves from a first intersection 921 to a second intersection 922, a third intersection 923, a 4^{th} intersection 924, a 5^{th} intersection 925, and a 6^{th} intersection 926 is sensed, the electronic device can store “211113” as numbers of the line segments on which the touches are sensed.

After detecting the numbers for the line segments on which the touches are sensed, the electronic device can release a pattern in consideration of the numbers for the line segments on which the touches are sensed. For example, as shown in FIG. 9B, when a touch is released after the first intersection 921, the second intersection 922, the third intersection 923, the 4^{th} intersection 924, the 5^{th} intersection 925, and the 6^{th} intersection 926 are successively sensed, the electronic device can release a pattern in consideration of the numbers “211113” of the line segments on which the touches are sensed. Herein, as shown in FIG. 9C, when a touch is released after a first intersection 931, a second intersection 932, a third intersection 933, a 4^{th} intersection 934, a 5^{th} intersection 935, and a 6^{th} intersection 936 are successively sensed, the electronic device can release a pattern in consideration of the numbers “211113” of the line segments on which the touches are sensed. That is, when the numbers of the line segments for releasing the pattern are “211113”, the electronic device can release the pattern when including the numbers “211113” of the line segments although shapes of the patterns differ from each other.

In addition, when the pattern is released, the electronic device can display, as shown in FIG. 9D, a wall paper 951. Also, when the pattern is released, the electronic device can execute a predetermined application program.

Thereafter, the electronic device ends the algorithm of FIG. 6A.

As described above, the process of performing the control operation to release the pattern using the polygon in the electronic device can be configured, as shown in FIG. 6B, an apparatus for performing the control operation to release the pattern using the polygon in the electronic device.

FIG. 6B is a block diagram illustrating configuration of an electronic device for releasing a pattern using a polygon according to one embodiment of the present disclosure.

Referring to FIG. 6B, the electronic device can include a polygon display means, that is, a first means 611 for displaying a polygon for releasing a pattern, a touch sensing means, that is, a second means 613 for sensing touches on line segments, a number detecting means, that is, a third means 615 for detecting numbers for the line segments on which the touches are sensed, and a pattern releasing means, that is, a 4^{th} means 617 for releasing a pattern in consideration of the numbers for the line segments on which the touches are sensed.

The first means 611 displays the polygon for releasing the pattern. For example, as shown in FIG. 9A, the first means 611 can display a triangle 903 for releasing a pattern on a touch panel 901. Herein, the first means 611 can verify that a first line segment 911 forming the triangle 903 is 1, a second line segment 913 is 2, and a third segment 915 is 3.

The second means 613 can sense the touches on the line segments.

The third means 615 can detect numbers for the line segments on which the touches are sensed. For example, as shown in FIG. 9B, when a touch movement which moves from a first intersection 921 to a second intersection 922, a third intersection 923, a 4^{th} intersection 924, a 5^{th} intersection 925, and a 6^{th} intersection 926 is sensed, the third means 615 can store “211113” as numbers of the line segments on which the touches are sensed.

The 4^{th} means 617 can release the pattern in consideration of the numbers for the line segments on which the touches are sensed. When a touch is released after the first intersection 921, the second intersection 922, the third intersection 923, the 4^{th} intersection 924, the 5^{th} intersection 925, and the 6^{th} intersection 926 are successively sensed, the 4^{th} means 617 can release a pattern in consideration of the numbers “211113” of the line segments on which the touches are sensed. Herein, as shown in FIG. 9C, when a touch is released after a first intersection 931, a second intersection 932, a third intersection 933, a 4^{th} intersection 934, a 5^{th} intersection 935, and a 6^{th} intersection 936 are successively sensed, the 4^{th} means 617 can release a pattern in consideration of the numbers “211113” of the line segments on which the touches are sensed. That is, when the numbers of the line segments for releasing the pattern are “211113”, the 4^{th} means 617 can release the pattern when including the numbers “211113” of the line segments although shapes of the patterns differ from each other.

In addition, when the pattern is released, the 4^{th} means 617 can display, as shown in FIG. 9D, a wall paper 951. Also, when the pattern is released, the 4^{th} means 617 can execute a predetermined application program.

In addition, the electronic device can further include at least one means before the first means 611 and after the 4^{th} means 617

As described above, the electronic device can include a plurality of means for performing the control operation to release the pattern using the polygon. Herein, the electronic device can include the plurality of means for performing the control operation to release the pattern using the polygon as one means.

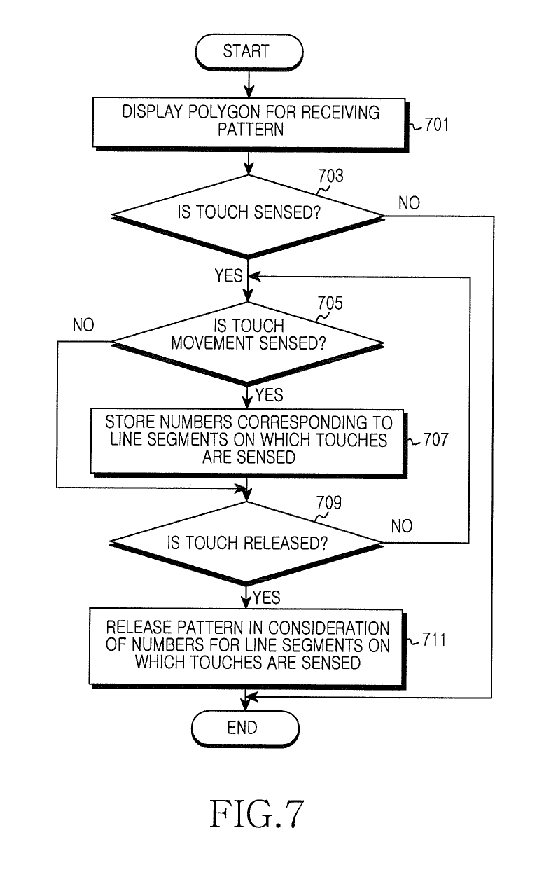

FIG. 7 is a flowchart illustrating a process of releasing a pattern using a polygon in an electronic device according to another embodiment of the present disclosure.

Referring to FIG. 7, the electronic device displays a polygon for releasing a pattern in step 701. For example, as shown in FIG. 9A, the electronic device can display a triangle 903 for releasing a pattern on a touch panel 901. Herein, the electronic device can verify that a first line segment 911 forming the triangle 903 is 1, a second line segment 913 is 2, and the third line segment 915 is 3.

After displaying the polygon for releasing the pattern, the electronic device can verify whether a touch is sensed in step 703. If the touch is not sensed, the electronic device can end the algorithm of FIG. 7.

On the other hand, when the touch is sensed, the electronic device can verify whether a touch movement is sensed in step 705. If the touch movement is not sensed, the electronic device can verify whether the touch is released in step 709.

On the other hand, when the touch movement is sensed, the electronic device can store numbers for line segments on which the touches are sensed in step 707. For example, as shown in FIG. 9B, when a touch movement which moves from a first intersection 921 to a second intersection 922, a third intersection 923, a 4^{th} intersection 924, a 5^{th} intersection 925, and a 6^{th} intersection 926 is sensed, the electronic device can store “211113” as numbers of the line segments on which the touches are sensed.

After storing the numbers for the line segments on which the touches are sensed, the electronic device can verify whether the touch is released in step 709. If the touch is not released, the electronic device can verify whether a touch movement for line segments is sensed in step 705.

On the other hand, when the touch is released, the electronic device can release a pattern in consideration of the numbers for the line segments on which the touches are sensed in step 711. For example, as shown in FIG. 9B, when a touch is released after the first intersection 921, the second intersection 922, the third intersection 923, the 4^{th} intersection 924, the 5^{th} intersection 925, and the 6^{th} intersection 926 are successively sensed, the electronic device can release a pattern in consideration of the numbers “211113” of the line segments on which the touches are sensed. Herein, as shown in FIG. 9C, when a touch is released after a first intersection 931, a second intersection 932, a third intersection 933, a 4^{th} intersection 934, a 5^{th} intersection 935, and a 6^{th} intersection 936 are successively sensed, the electronic device can release a pattern in consideration of the numbers “211113” of the line segments on which the touches are sensed. That is, when the numbers of the line segments for releasing the pattern are “211113”, the electronic device can release the pattern when including the numbers “211113” of the line segments although shapes of the patterns differ from each other.

In addition, when the pattern is released, the electronic device can display, as shown in FIG. 9D, a wall paper 951. Also, when the pattern is released, the electronic device can execute a predetermined application program.

Thereafter, the electronic device can end the algorithm of FIG. 7.

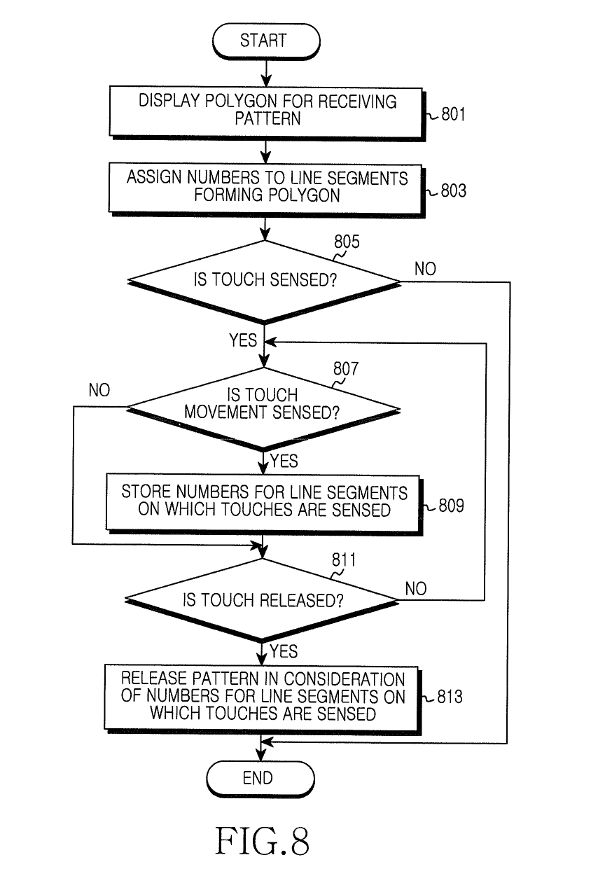

FIG. 8 is a flowchart illustrating a process of releasing a pattern using a polygon in an electronic device according to another embodiment of the present disclosure.

Referring to FIG. 8, the electronic device displays a polygon for releasing a pattern in step 801. For example, as shown in FIG. 9A, the electronic device can display a triangle 903 for releasing a pattern on a touch panel 901.

After displaying the polygon for releasing the pattern, the electronic device can verify numbers for line segments forming the polygon in step 803. For example, as shown in FIG. 9A, the electronic device can verify that a first line segment 911 forming the triangle 903 is 1, a second line segment 913 is 2, and a third line segment 915 is 3.

After determining the numbers for the line segments forming the polygon, the electronic device can verify whether a touch is sensed in step 805. If the touch is not sensed, the electronic device can end the algorithm of FIG. 8.

On the other hand, when the touch is sensed, the electronic device can verify whether a touch movement is sensed in step 807. If the touch movement is not sensed, the electronic device can verify whether the touch is released in step 811.

On the other hand, when the touch movement is sensed, the electronic device can store numbers for line segments on which the touches are sensed in step 809. For example, as shown in FIG. 9B, when a touch movement which moves from a first intersection 921 to a second intersection 922, a third intersection 923, a 4^{th} intersection 924, a 5^{th} intersection 925, and a 6^{th} intersection 926 is sensed, the electronic device can store “211113” as numbers of the line segments on which the touches are sensed.

After storing the numbers for the line segments on which the touches are sensed, the electronic device can recognize whether the touch is released in step 811. If the touch is not released, the electronic device can continue to monitor whether a touch movement for line segments is sensed in step 807.

On the other hand, when the touch is released, the electronic device can release a pattern in consideration of the numbers for the line segments on which the touches are sensed in step 813. For example, as shown in FIG. 9B, when a touch is released after the first intersection 921, the second intersection 922, the third intersection 923, the 4^{th} intersection 924, the 5^{th} intersection 925, and the 6^{th} intersection 926 are successively sensed, the electronic device can release a pattern in consideration of the numbers “211113” of the line segments on which the touches are sensed. Herein, as shown in FIG. 9C, when a touch is released after a first intersection 931, a second intersection 932, a third intersection 933, a 4^{th} intersection 934, a Stn intersection 935, and a 6^{th} intersection 936 are successively sensed, the electronic device can release a pattern in consideration of the numbers “211113” of the line segments on which the touches are sensed. That is, when the numbers of the line segments for releasing the pattern are “211113”, the electronic device can release the pattern when including the numbers “211113” of the line segments although shapes of the patterns differ from each other.

In addition, when the pattern is released, the electronic device can display, as shown in FIG. 9D, a wall paper 951. Also, when the pattern is released, the electronic device can execute a predetermined application program.

Thereafter, the electronic device can end the algorithm of FIG. 8.

In the above-described one embodiment of the present disclosure, the electronic device can release the pattern in consideration of the touches on the line segments forming the triangle.

In another embodiment of the present disclosure, the electronic device can release a pattern in consideration of touches on line segments forming a rectangle. For example, as shown in FIG. 10A, displaying a rectangle 1003 for releasing a pattern on a touch panel 1001, the electronic device can release a pattern in consideration of touch information about a first line segment 1011, a second line segment 1013, a third line segment 1015, and a 4^{th} line segment 1017 which form the rectangle 1003. For example, as shown in FIG. 10B, when a first intersection 1021, a second intersection 1022, a third intersection 1023, and a 4^{th} intersection 1024 on at least one line segment forming the rectangle 1003 are successively sensed, the electronic device can release a pattern in consideration of numbers “4123” of the line segments on which the touches are sensed. Herein, as shown in FIG. 10C, when a first intersection 1031, a second intersection 1032, a third intersection 1033, and a 4^{th} intersection 1034 on at least one line segment forming the rectangle 1003 are successively sensed, the electronic device can release a pattern in consideration of the numbers “4123” of the line segments on which the touches are sensed. That is, when the numbers of the line segments for releasing the pattern are “4123”, the electronic device can release the pattern when including the numbers “4123” of the line segments although shapes of the patterns differ from each other.

In another embodiment of the present disclosure, the electronic device can release a pattern in consideration of touches on an image. For example, as shown in FIG. 11A, displaying an image 1103 for releasing pattern on a touch panel 1101, the electronic device can recognize the image 1103 as a polygon 1105. Herein, as shown in FIG. 11B, the electronic device can release a pattern in consideration of touch information about first to 16^{th} line segments 1111 to 1126 forming the 16-polygon 1105. For example, as shown in FIG. 11C, a first intersection 1141, a second intersection 1142, a third intersection 1143, a 4^{th} intersection 1144, a 5^{th} intersection 1145, a 6^{th} intersection 1146, a 7^{th} intersection 1147, and an 8^{th} intersection 1148 on at least one line segment forming the 16-polygon 1105 are successively sensed, the electronic device can release a pattern in consideration of numbers “12346151211” of the line segments on which the touches are sensed. Herein, as shown in FIG. 11D, when a first intersection 1061, a second intersection 1062, a third intersection 1063, and a 4^{th} intersection 1064, a 5^{th} intersection 1165, a 6^{th} intersection 1166, a 7^{th} intersection 1167, and an 8^{th} intersection 1168 on at least one line segment forming the 16-polygon 1105 are successively sensed, the electronic device can release a pattern in consideration of the numbers “12346151211” of the line segments on which the touches are sensed. That is, when the numbers of the line segments for releasing the pattern are “12346151211”, the electronic device can release the pattern when including the numbers “12346151211” of the line segments although shapes of the patterns differ from each other.

As described above, there is an advantage in that the electronic device according to various embodiments of the present disclosure can allow the user thereof to raise degree of difficulty of a pattern by freely setting the pattern using the polygon and freely set the pattern because there is no limit to a repeated pattern.

Methods according to claims of the present disclosure or embodiments described in the specification of the present disclosure can be implemented as hardware, software, or combinational type of the hardware and the software.

When the method is implemented by the software, a computer-readable storage medium for storing one or more programs (software modules) can be provided. The one or more programs stored in the computer-readable storage medium are configured for being executed by one or more processors in an electronic device. The one or more programs include instructions for allowing an electronic device to execute the methods according to the claims of the present disclosure and/or the embodiments described in the specification of the present disclosure.

These programs (software module, software) can be stored in a Random Access Memory (RAM), a non-volatile memory including a flash memory, a Read Only Memory (ROM), an Electrically Erasable Programmable ROM (EEPROM), a magnetic disc storage device, a Compact Disc-ROM (CD-ROM), a Digital Versatile Disc (DVD) or an optical storage device of a different type, and a magnetic cassette. Or, the programs can be stored in a memory configured by combination of some or all of them. Also, the configured memory can include a plurality of memories.

Also, the programs can stored in an attachable storage device capable of accessing an electronic device through each of communication networks such as the Internet, an intranet, a Local Area Network (LAN), a Wide LAN (WLAN), and a Storage Area Network (SAN) or a communication network configured by combination of them. This storage device can connect to the electronic device through an external port.

Also, a separate storage device on a communication network can connect to a portable electronic device.

While the present disclosure has been particularly shown and described with reference to exemplary embodiments thereof, it will be understood by those skilled in the art that various changes in form and details may be made therein without departing from the spirit and scope of the present disclosure as defined by the appended claims.

What is claimed is:

1. A method in an electronic device, the method comprising:
displaying a polygon comprising a plurality of line segments on a screen;
receiving a drag input from a user; and
detecting at least one intersection between the drag input and one of the plurality of line segments.

2. The method of claim 1, further comprising:
determining a pattern based on a sequence of at least one intersection.

3. The method of claim 1, further comprising:
assigning each integer or letter to each of the plurality of line segments; and

4. The method of claim 3, further comprising:
producing a code by converting each intersection on the line segment to respective assigned integers or letters of the line segments.

5. The method of claim 1, further comprising:
recognizing an image from the received drag input.

6. The method of claim 1, further comprising:
determining a pattern based on a sequence of at least one intersection; and
assigning different integers or letters to each of the plurality of line segments based on whether the pattern comprises a clockwise arc or a counter-clockwise arc.

7. The method of claim 6, further comprising:
producing a code by converting each intersection on the line segment to respective assigned integers or letters of the line segments.

8. The method of claim 2, further comprising:
unlocking the screen when the pattern matches a preset pattern.

9. The method of claim 1, wherein the polygon is a triangle or rectangle.

10. The method of claim 2, further comprising unlocking an application program when the code matches a password.

11. An electronic device for receiving a pattern, the electronic device comprising:
at least one memory;
a display; and
at least one processor configured to:
display a polygon comprising a plurality of line segments on a screen;
receive a drag input from a user; and
detect at least one intersection between the drag input and one of the plurality of line segments.

12. The electronic device of claim 11, wherein the controller is configured to determine a pattern based on a sequence of at least one intersection.

13. The electronic device of claim 11, wherein the controller is configured to assign each integer or letter to each of the plurality of line segments; and

14. The electronic device of 13, wherein the controller is configured to produce a code by converting each intersection on the line segment to respective assigned integers or letters of the line segments.

15. The electronic device of 11, wherein the controller is configured to recognize an image from the received drag input.

16. The electronic device of 11, wherein the controller is configured to:
determining a pattern based on a sequence of at least one intersection; and
assigning different integers or letters to each of the plurality of line segments based on whether the pattern comprises a clockwise arc or a counter-clockwise arc.

17. The electronic device of 16, wherein the controller is configured to produce a code by converting each intersection on the line segment to respective assigned integers or letters of the line segments.

18. The electronic device of 12, wherein the controller is configured to unlock the screen when the pattern matches a preset pattern.

19. The electronic device of 11, wherein the polygon is a triangle or rectangle.

20. The electronic device of 12, wherein the controller is configured to unlock an application program when the code matches a password.
